(19) United States
(12) Patent Application Publication
(10) Pub. No.: US 2015/0270615 A1
(43) Pub. Date: Sep. 24, 2015

(54) High Frequency GPS GNN GLONASS Antenna

(71) Applicant: Michael Andrew Neenan, Plano, TX (US)

(72) Inventor: Michael Andrew Neenan, Plano, TX (US)

(21) Appl. No.: 14/512,162

(22) Filed: Oct. 10, 2014

Related U.S. Application Data
(60) Provisional application No. 61/889,517, filed on Oct. 10, 2013.

(51) Int. Cl. H01Q 9/42; G01S 19/36

(52) U.S. Cl. CPC H01Q 9/42; G01S 19/36

(57) ABSTRACT

An antenna for receiving global positioning signals may include a first antenna section and a second antenna section adjacent to the first antenna section to form a row of antenna sections. The first antenna section may be connected to a first and second terminal to connect to a connecting plate.

### PRIORITY

The present invention claims priority under 35 USC section 119 based on a provisional application with a Ser. No. 61/889517 filed on Oct. 10, 2013.

### FIELD OF THE INVENTION

The present invention relates to antennas and more particularly to an antenna for receiving positional information.

### BACKGROUND

GPS satellites transmit GPS signals at two frequencies, referred to as the L1 and L2 frequencies. The L1 frequency is 1575.42 MHz. The L2 frequency is 1227.60 MHz. The GPS signals are right-hand circularly polarized.

GPS antennae are used to receive GPS signals.

The Global Positioning System (GPS) is a navigation system featuring a constellation of 24 satellites that traverse six circular orbits around the Earth twice a day, with four satellites in each orbit. The satellites transmit coded L-band microwave radio frequency (RF) signals, and are always positioned so that signals from at least four of the satellites can be received at any point on Earth.

Specifically, each GPS satellite presently transmits its signals using two RF carrier frequencies, viz., 1575.42 MHZ (referred to as “L1”) and 1227.60 MHZ (“L2”). A third frequency of 1176.45 MHZ (“L5”) has also been allocated for civilian use in 2009. The L1 signal is modulated by two different spread spectrum codes, namely, an unclassified coarse acquisition (C/A) code intended for use in commercial civil navigation equipment, and a Y code that is modulated on the L1 carrier in quadrature with the C/A code and with half the power of the C/A code. The Y code is a product of an unclassified P (precise) code, and a classified W code. The C/A and the P codes are unique for each satellite. The satellite antennas are configured so that the GPS signals have a right-hand circular polarization (RHCP) as they propagate toward the Earth (See U.S. Pat. No. 8,049,667).

Basically, a GPS receiver compares time data as encoded on a signal received from a given satellite, with a local time at which the signal was received. The time difference is then used to calculate the distance between the receiver and the transmitting satellite. Using calculated distances from at least three satellites, the receiver determines its position on Earth by known triangulation techniques. With four or more satellites in view, the receiver can determine its altitude as well. Once the receiver's position is determined, it may calculate other information such as speed, bearing, and distance to a given destination.

The transmitted signals are subject to degradation by several factors including, inter alia, signal multipath which occurs when a GPS signal reflects off of objects such as buildings or other tall surfaces before reaching the receiver. The calculated distance to the transmitting satellite based on a reflected GPS signal will be greater than the actual line of sight distance, thus causing error in the position determined by the receiver. Other degrading factors may include receiver clock errors, orbital (ephemeris) errors, number of satellites visible (the fewer satellites in view, the lower the accuracy), and the relative positions of the satellites at any given time (accuracy degrades when the satellites are spaced angularly close to one another as seen from the receiver). In a tactical or military environment, intentional jamming is another factor that must be overcome to maintain GPS receiver accuracy.

For greatest accuracy and safety, a ground station or aircraft carrier in a DGPS landing system deploys so-called reference antennas that are configured to respond optimally to the right-hand circularly polarized (RHCP) signals from the GPS satellites, and to supply the signals to GPS receivers and correction data generating equipment at the station or aboard the carrier. Due to the complex physical and electromagnetic environment of an aircraft carrier, as many as three or more precision GPS reference antennas may need to be installed at determined locations on the carrier so that accurate position correction and other critical data can be determined and transmitted to approaching aircraft or other landing platforms.

To avoid position offset errors, each reference antenna must have a well-defined phase center, and introduce known carrier phase and code phase delays into signals arriving at any given angle of the antenna's reception pattern. The phase center of a GPS receiving antenna is defined as the precise point whose position is being measured in response to GPS signals incident on the antenna. The location of the phase center may vary with the direction of arrival of a given GPS signal mainly as a function of satellite elevation, while azimuth effects may be introduced locally by the environment around the antenna. Thus, it will be understood that ignoring variations in the phase center of a GPS receiving antenna can lead to serious errors in position measurement. See, e.g., G. L. Mader, GPS Antenna Calibration at the National Geodetic Survey, at—http://www.ngs.noaa.gov/ANTCAL/images/summary.html=, F. Czopek, et al., Calibrating Antenna Phase Centers, GPS World (May 2002); and A. Boussaad, et al., A Tale of Two Methods, GPS World (February 2005).

Carrier phase delay is a delay induced on a received GPS signal at its carrier frequency, while code phase delay is a delay induced on the signal over the signal's bandwidth. An ideal GPS right-hand circular polarization reference antenna should have a carrier phase progression of one degree of carrier phase delay per degree of azimuth arrival angle, and remain constant relative to elevation at any given azimuth angle. The antenna should also have a constant code phase delay with angle.

There are other causes of distortion. Wearing a GPS antenna in a close relationship to the body can result in other forms of distortion.

A satellite navigation system with global coverage may be termed a global navigation satellite system or GNSS. The BeiDou Navigation Satellite System is a Chinese satellite navigation system. It consists of two separate satellite constellations—a limited test system that has been operating since 2000, and a full-scale global navigation system that is currently under construction.

GLONASS, an acronym for “Globalnaya navigatsionnaya sputnikovaya sistema” or “Global Navigation Satellite System”, is a space-based satellite navigation system operated by the Russian Aerospace Defense Forces. It provides an alternative to Global Positioning System (GPS) and is the second alternative navigational system in operation with global coverage and of comparable precision.

Galileo is a global navigation satellite system (GNSS) currently being built by the European Union (EU) and European Space Agency (ESA), intended for civilian use only. The Galileo is named after the Italian astronomer Galileo Galilei. One of the aims of Galileo is to provide an alternative high-precision positioning system upon which European nations can rely, independently from the Russian GLONASS and US GPS systems,

### SUMMARY

An antenna for receiving global positioning signals may include a first antenna section and a second antenna section adjacent to the first antenna section to form a only a single row of antenna sections.

The first antenna section may be connected to a first and second terminal to connect to a connecting plate.

The first antenna section may include a U-shaped section.

The first antenna section may include an inverted U-shaped section.

The first antenna section may include a first longitudinal section.

The first antenna section may include a second longitudinal section.

The second antenna section may include a U-shaped section.

The second antenna section may include inverted U-shaped section.

The second antenna section may include a first longitudinal section.

The second antenna section may include a second longitudinal section.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of a GPS antenna of the present invention;

FIG. 2 illustrates an antenna section of the GPS antenna of the present invention;

FIG. 3 illustrates a top view of the antenna section of the GPS antenna of the present invention;

FIG. 4 illustrates a bottom view of the antenna section of the GPS antenna of the present invention;

FIG. 5 illustrates a front perspective view of the GPS antenna of the present invention;

FIG. 6 illustrates a back perspective view of the GPS antenna of the present invention;

FIG. 7 illustrates a front view of the GPS antenna of the present invention;

FIG. 8 illustrates another antenna of the present invention;

FIG. 9 illustrates another antenna of the present invention;

FIG. 10 illustrates a another antenna of the present invention;

FIG. 11 illustrates another antenna of the present invention;

FIG. 12 illustrates a graph of the antenna of the present invention;

FIG. 13 illustrates a far field directivity of the antenna of the present invention;

FIG. 14 illustrates another far field directivity of the antenna of the present invention;

FIG. 15 illustrates a graph of the antenna of the present invention;

FIG. 16 illustrates another far field directivity of the present invention;

FIG. 17 illustrates another far field directivity of the antenna of the present invention;

FIG. 18 illustrates S-parameter of the antenna of the present invention;

FIG. 19 illustrates a bottom view of the antenna of the present invention;

FIG. 20 illustrates a perspective view of the antenna of the present invention;

FIG. 21 illustrates far field directivity of the antenna of the present invention;

FIG. 22 illustrates far field directivity of the antenna of the present invention;

FIG. 23 illustrates the S-parameter of the antenna of the present invention;

FIG. 24 illustrates far field directivity of the antenna of the present invention;

FIG. 25 illustrates far field directivity of the antenna of the present invention;

FIG. 26 illustrates another antenna of the present invention;

FIG. 27 illustrates a another antenna of the present invention;

FIG. 28 illustrates another antenna of the present invention;

FIG. 29 illustrates another antenna of the present invention;

FIG. 30 illustrates another antenna of the present invention.

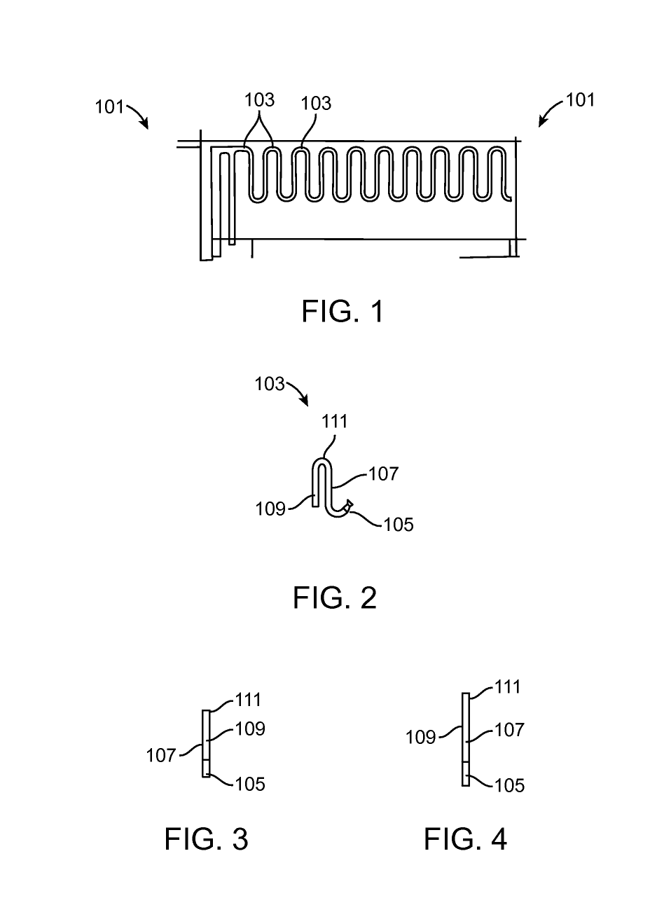

### DETAILED DESCRIPTION

The antenna 101 may be formed from a continuous wire or may be a multitude of connected wires which may have a circular, oval, rectangular or other shaped cross-section, and the wire may be bare or may have a coating of insulating material. Alternatively, the entire antenna 101 may be covered with a protective coating which may be relatively transparent to signals being transmitted. The antenna 101 may stand upright at an acute angle with respect to a support surface 113, may be positioned upright at an angle of substantially 90° with respect to the support surface 113 or may be positioned parallel to the support surface 113.

The antenna 101 may include an array of antenna sections 103 which may be formed in a linear alignment (only a single row) where one antenna section 103 is adjacent to second antenna section 103, and a third antenna section 103 is adjacent to the second antenna section 103. In this arrangement, the antenna sections 103 are aligned in a single row. The antenna 101 may be trimable in order for the antenna to be tuned to the needs of a connected circuit. This tuning may achieve maximum power transfer between the antenna 101 and be connected circuit (not shown). In order to tune, the desired length of the row of antenna elements 103 may be determined and the excess number of antenna elements 103 may be separated from the antenna 101 in order to achieve the desired length. The separation may be achieved by separating weakened areas or cutting the excess antenna elements 103 from the antenna 101. Other arrangements are within the scope of the present invention may include rows and columns of the antenna sections 103.

FIG. 2 illustrates a side view of the antenna section 103 of the antenna 101 of the present invention, and the antenna section 103 may include an upright U shaped section 105 which may be connected to an end of a first longitudinal section 107. The first longitudinal section 107 may be connected to an inverted U-shaped section 111 at an opposing end of the first longitudinal section 107. The inverted U shaped section 111 may be connected to an end of a second longitudinal section 109 which may be connected at an opposing end to the U-shaped section 105 of an adjacent antenna section 103.

FIG. 3 illustrates a top view of the antenna section 103 of the antenna 101 of the present invention, and the antenna section 103 may include an upright U shaped section 105 which may be connected to an end of a first longitudinal section 107. The first longitudinal section 107 may be connected to an inverted U-shaped section 111 at an opposing end of the first longitudinal section 107. The inverted U shaped section 111 may be connected to an end of a second longitudinal section 109 which may be connected at an opposing end to the U-shaped section 105 of an adjacent antenna section 103.

FIG. 4 illustrates a bottom view of the antenna section 103 of the antenna 101 of the present invention, and the antenna section 103 may include an upright U shaped section 105 which may be connected to an end of a first longitudinal section 107. The first longitudinal section 107 may be connected to an inverted U-shaped section 111 at an opposing end of the first longitudinal section 107. The inverted U shaped section 111 may be connected to an end of a second longitudinal section 109 which may be connected at an opposing end to the U-shaped section 105 of an adjacent antenna section 103.

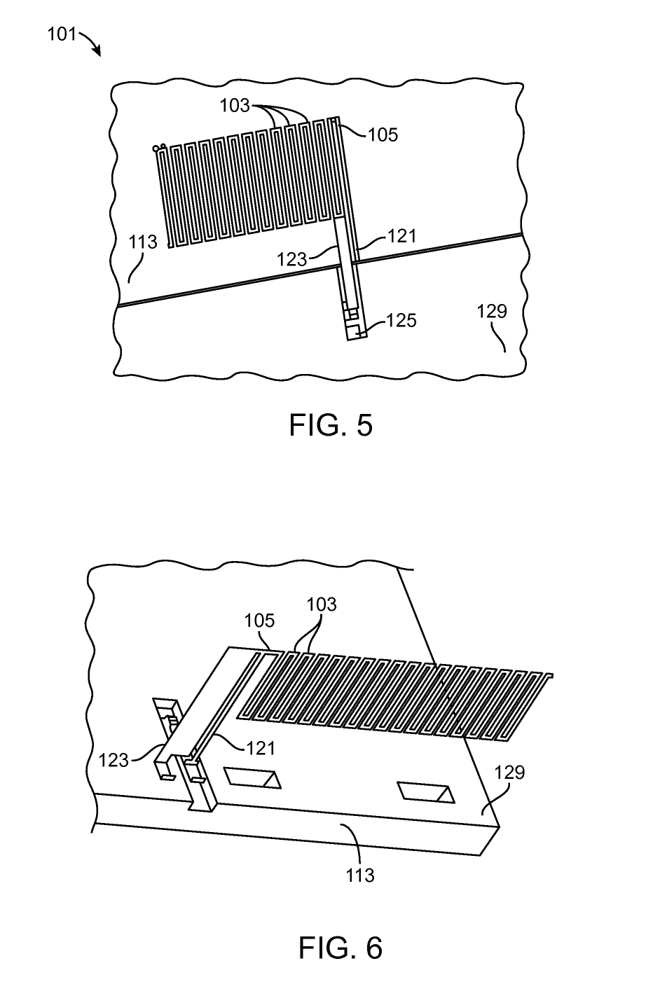

FIG. 5 illustrates a front perspective view of the GPS antenna of the present invention. More particularly, FIG. 5 illustrates a multitude of antenna sections 103 which may be a connected and the inverted U-shaped section 111 may be connected to a first terminal 121 which may be connected on opposing end of the first terminal 121 to the support surface 113 of a connecting plate 129. A second terminal 123 may be connected to the opposing upright U-shaped section 105 of the inverted U-shaped section 111, and the second terminal 123 may extend into the connecting plate 129 and may terminate within a channel 125 formed within the connecting plate 129.

FIG. 6 illustrates a back perspective view of the GPS antenna of the present invention. More particularly, FIG. 6 illustrates a multitude of antenna sections 103 which may be a connected and the inverted U-shaped section 111 may be connected to a first terminal 121 which may be connected on opposing end of the first terminal 121 to the support surface 113 of a connecting plate 129. A second terminal 123 may be connected to the first terminal 123 and may be connected to the inverted U-shaped section 111, and the second terminal 123 may extend into the connecting plate 129 and may terminate within a channel 125 formed within the connecting plate 129.

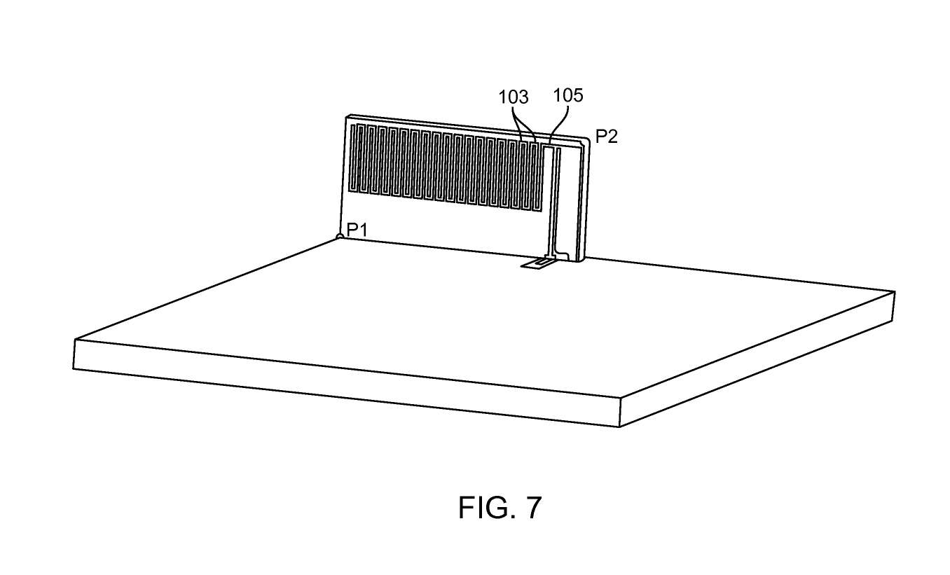

FIG. 7 illustrates a front view of the GPS antenna of the present invention.

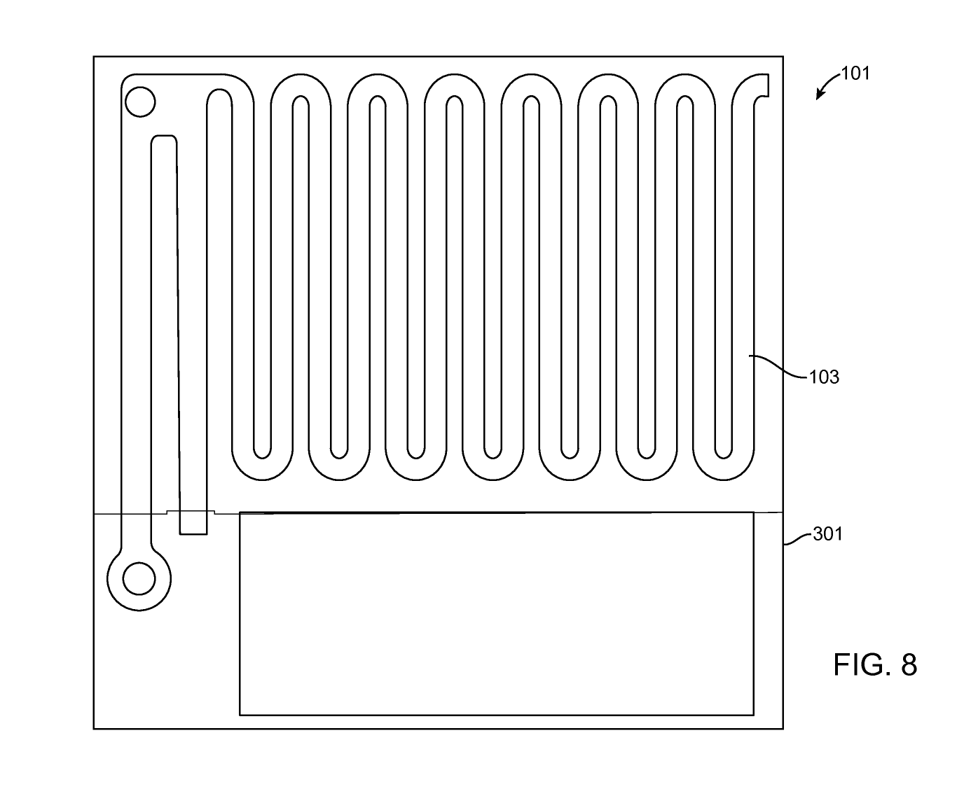

FIG. 8 illustrates another antenna 101 of the present invention. The antenna 101 may be a antenna sized at substantially 6×9 mm height or the is by width for reception of GPS.

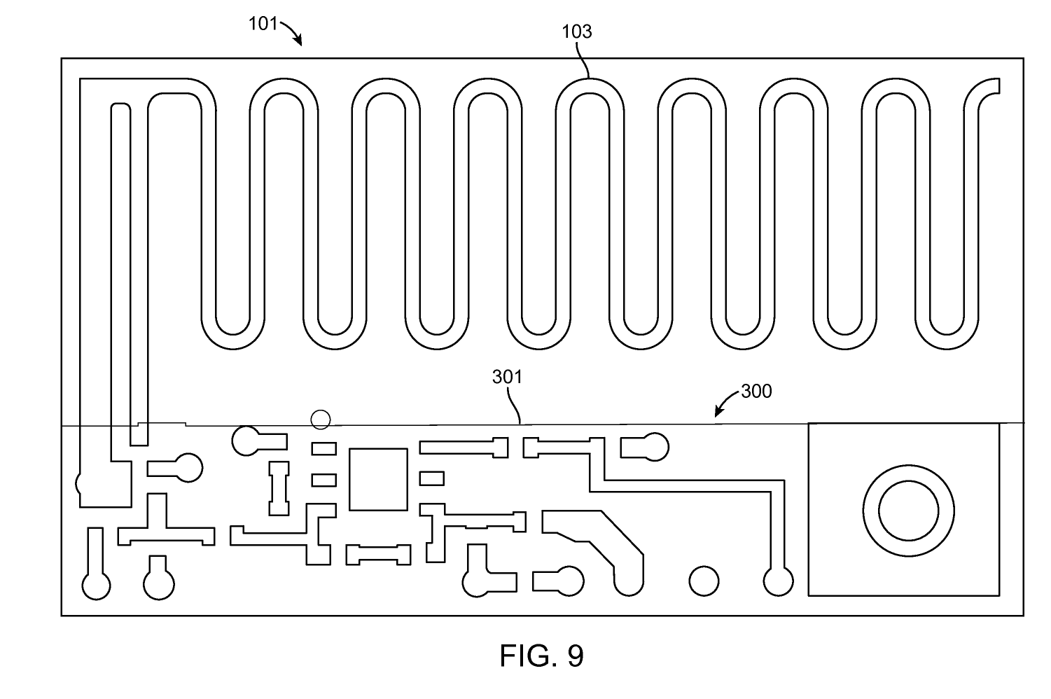

FIG. 9 illustrates another antenna is of the present invention. FIG. 9 illustrates an active antenna module 300 which may include the antenna 101 and an active circuit 301 (and/or passive circuit) which may be connected to the antenna 101. The antenna in FIG. 9 may be a substantial 6 mm by 16 mm antenna. The additional length is achieved by including additional antenna sections 103. FIG. 9 illustrates a GNSS antenna, which covers GPS, Beidou, Galileo and Glonass. All of the antennas 101 of the present invention cover and are operable in all 4 frequency ranges which are from substantially 1560-1610 MHz.

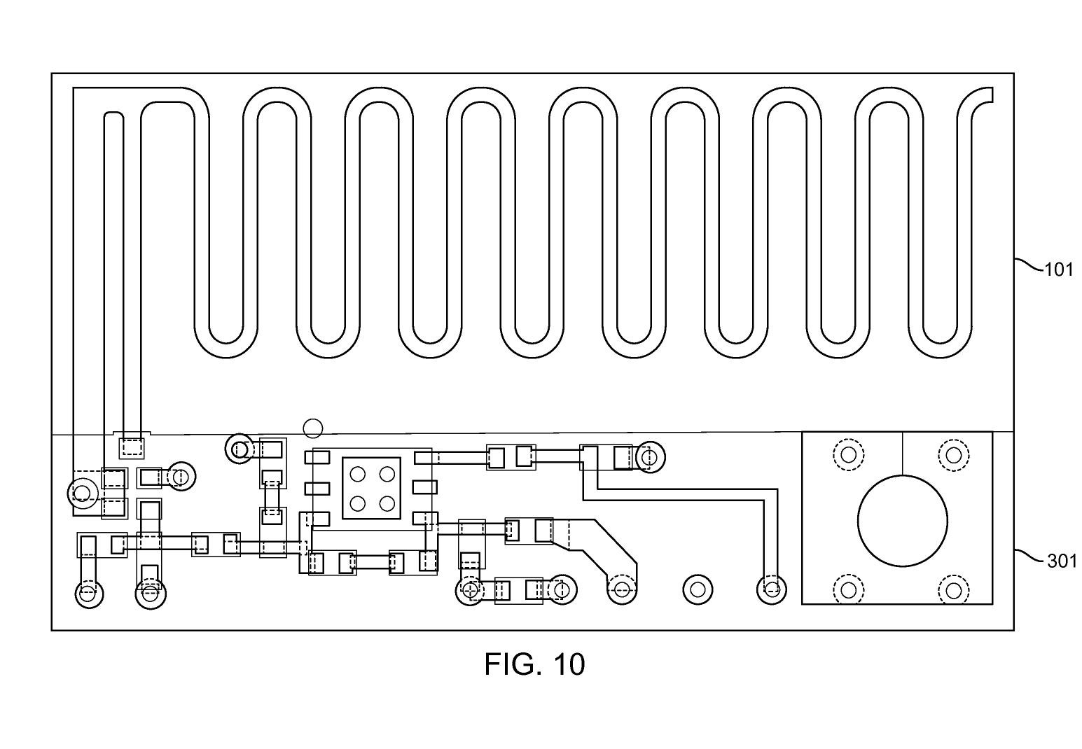

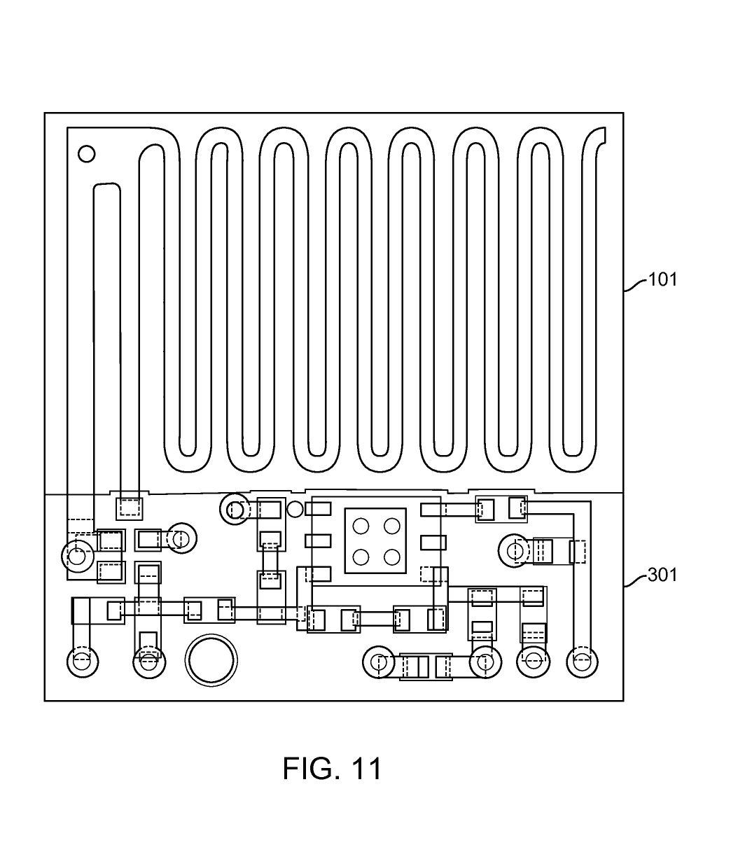

FIGS. 10 and 11 illustrate a another antenna 101 of the present invention which may be 6×9 mm and 6×16 mm active antennas respectively which may be connected to active circuits 301.

The near field (or near-field) and far field (or far-field) are regions of the electromagnetic field around an object, such as a transmitting antenna, or the result of radiation scattering off an object.

Scattering parameters or S-parameters (the elements of a scattering matrix or S-matrix) describe the electrical behavior of linear electrical networks when undergoing various steady state stimuli by electrical signals.

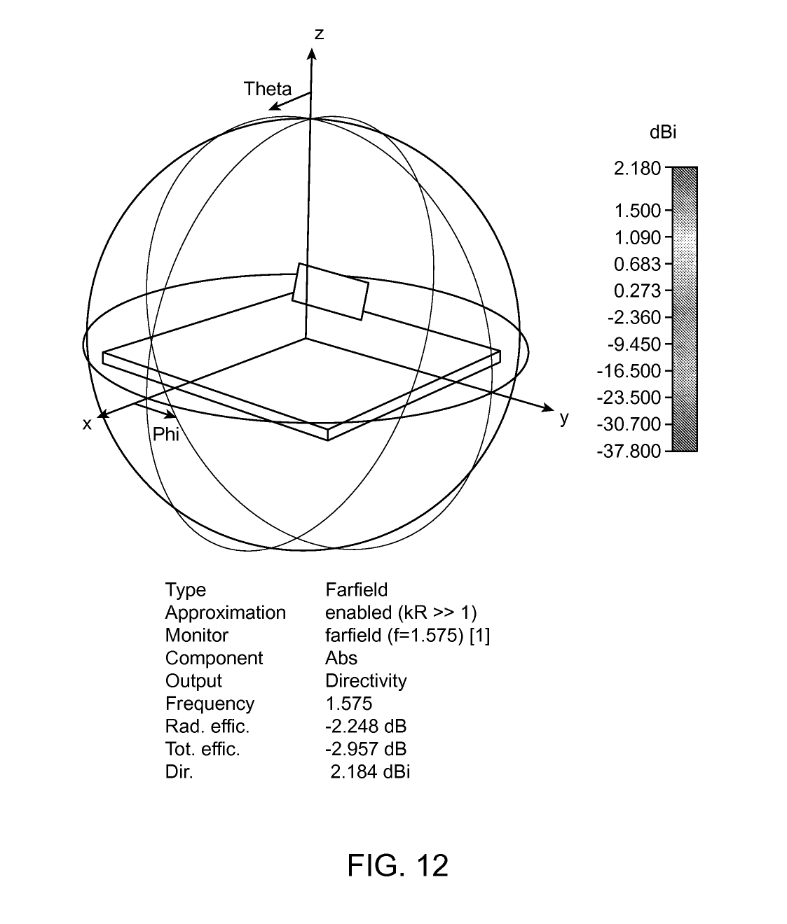

FIG. 12 illustrates a three-dimensional graph of the antenna 101 of the present invention which may be standing up.

FIG. 12 illustrates far field (or far-field) regions of the electromagnetic field around the antenna 101.

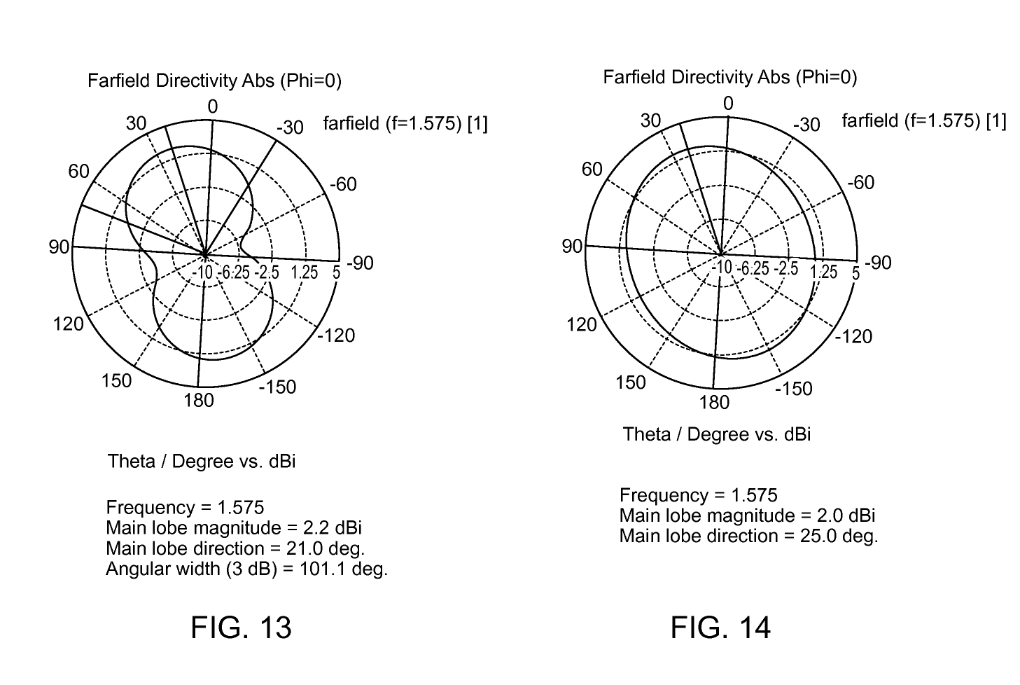

FIGS. 13 and 14 illustrate planar cuts. FIG. 13 illustrates a far field directivity (Phi=0) of the antenna 101 of the present invention showing Theta per degree dBi where dB (isotropic) is the forward gain of an antenna compared with the hypothetical isotropic antenna, which uniformly distributes energy in all directions. Linear polarization of the EM field is assumed unless noted otherwise.

FIG. 14 illustrates a far field directivity (Phi=90) of the antenna 101 of the present invention showing Theta per degree dBi of the antenna 101 of the present invention.

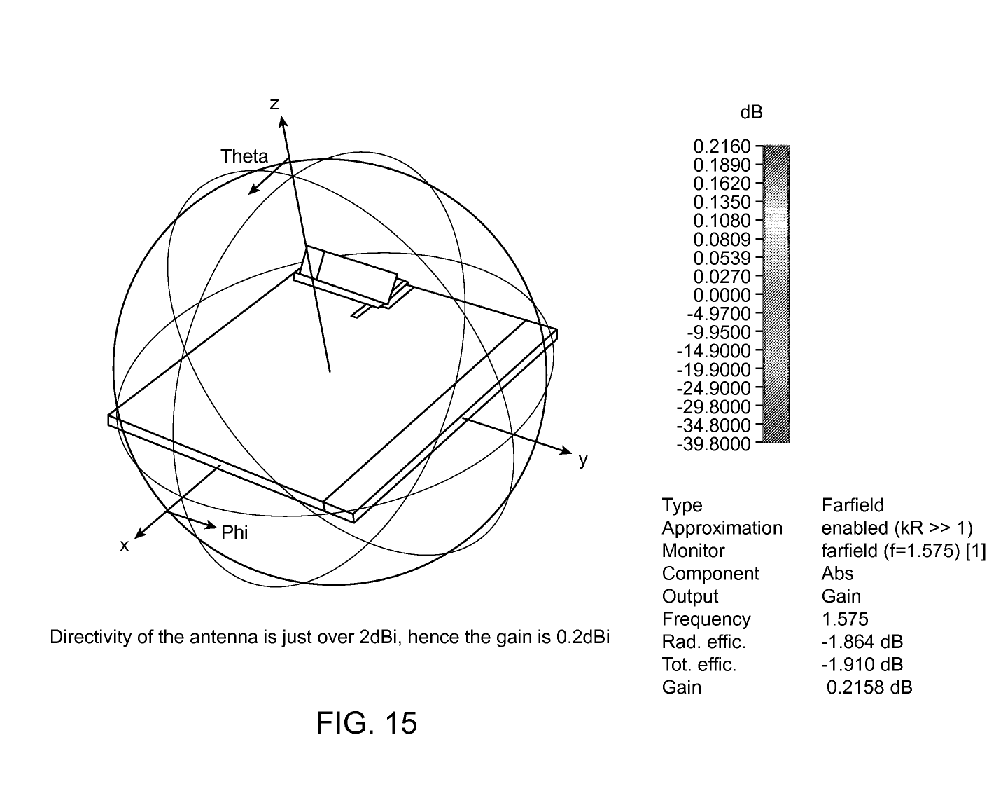

FIG. 15 illustrates a graph of the antenna of the present invention where efficiency is 64%.

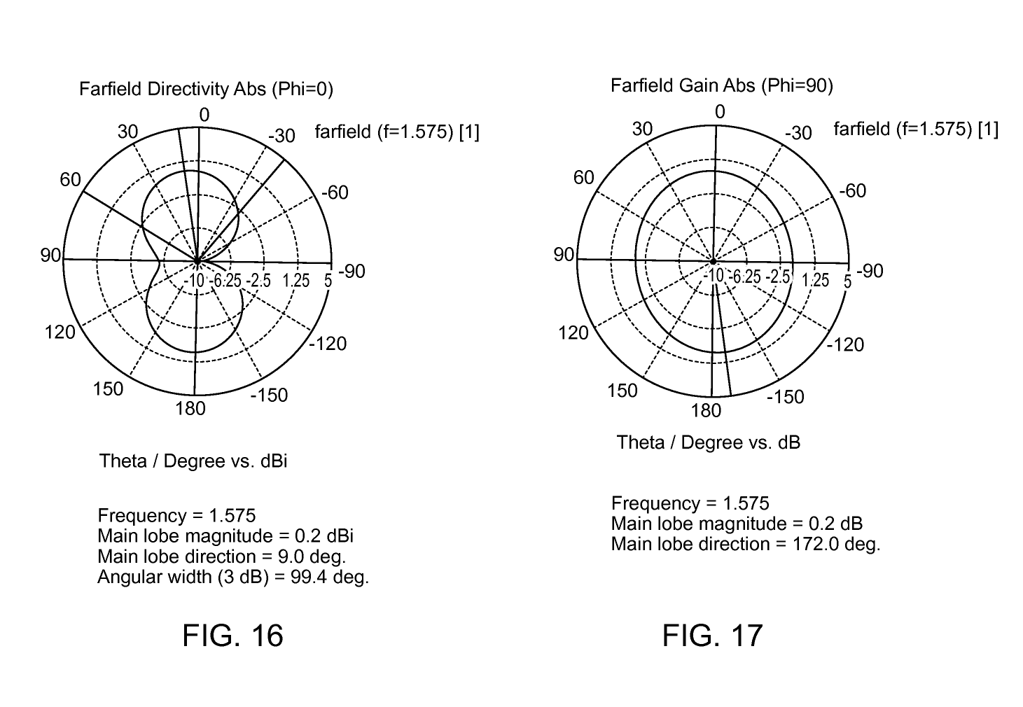

FIG. 16 illustrates another far field directivity in a polar pattern of the antenna 101 of the present invention.

FIG. 17 illustrates another far field directivity in a polar pattern of the antenna of the present invention;

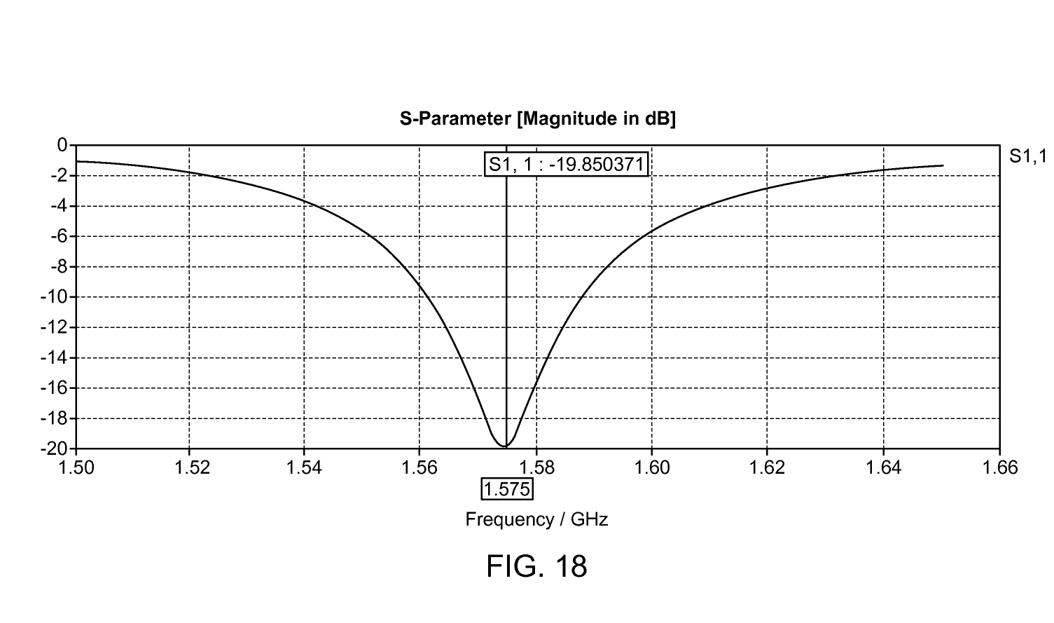

FIG. 18 illustrates S-parameter of the antenna 101 of the present invention.

In summary, the antenna 101 achieves substantially a 2.0 dBi gain at substantially 1575 MHz. A lay down antenna may have substantial dimensions of 6 mm (H)×14.25 mm (W). The standing antenna may have a substantial dimension of 6.550 mm (H)×17.35 mm (w). The efficiency may be 63% for 1560 MHz and 60% for 1602 MHz.

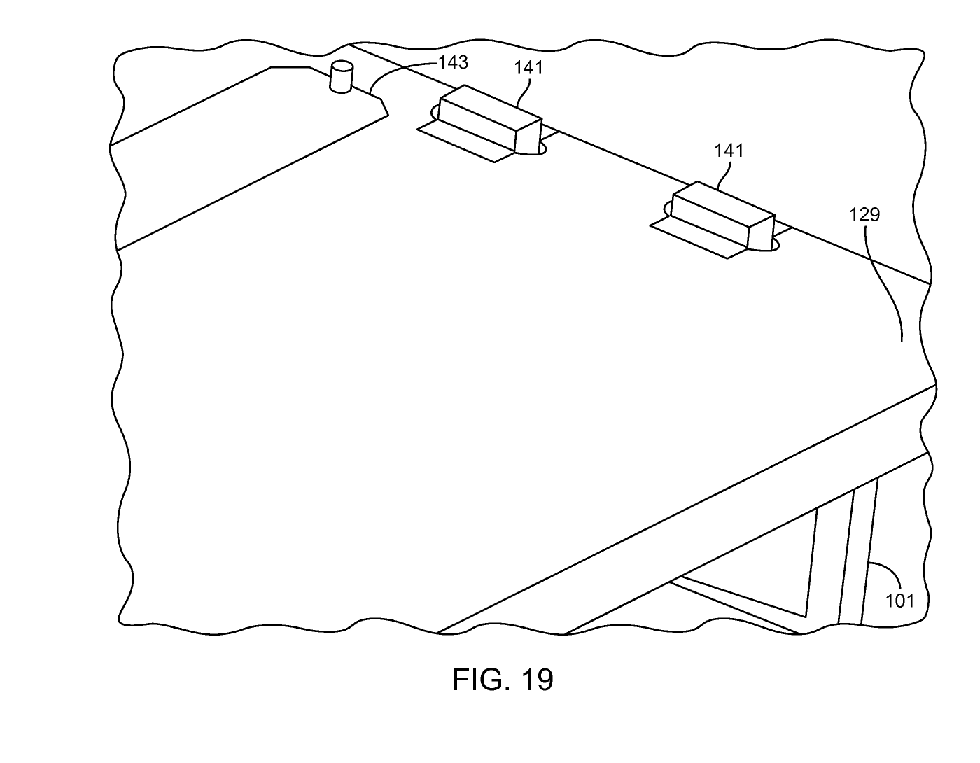

FIG. 19 illustrates a bottom view of the antenna 101 of the present invention. The antenna 101 may include tabs 141 which may extend through an aperture in the connecting plate 129 and the antenna 101 may be connected to a feed point 143 which may be a terminal on the bottom surface of the connecting plate.

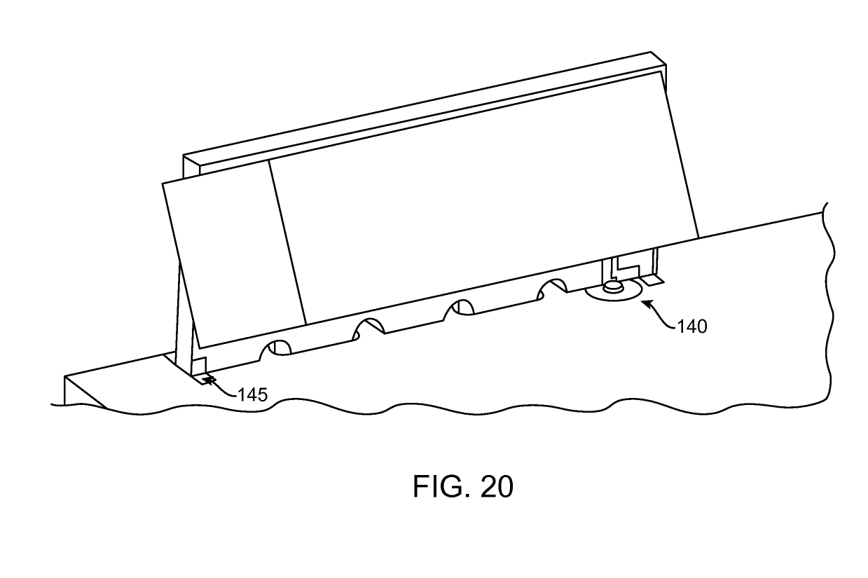

FIG. 20 illustrates a perspective view of the antenna of the present invention and illustrates a surface mounting holding tab 145 on the support surface of the connecting plate 129 to hold the antenna 101 in position. Furthermore a second feed point 1474 connection to a terminal of the antenna 101.

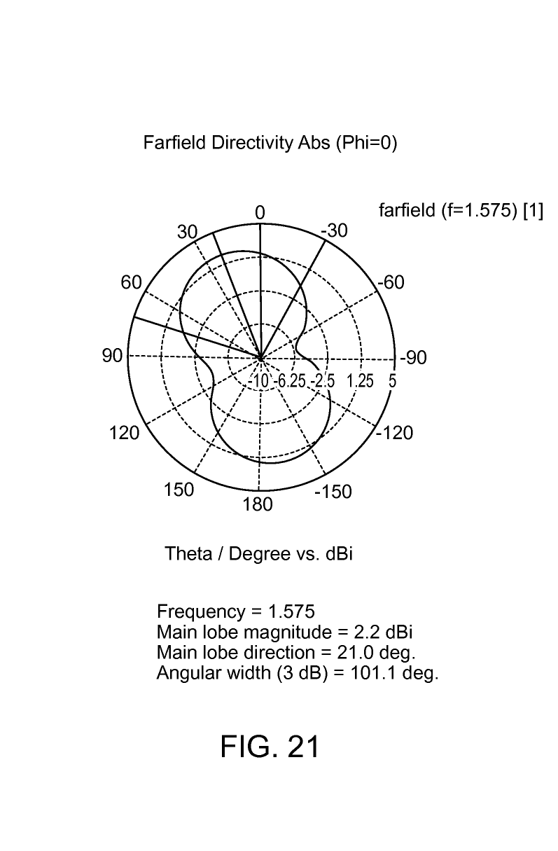

FIGS. 21-25 illustrate the far field Directivity for a vertical antenna having enhanced performance for wearable GPS/GNSS reception

FIG. 21 illustrates another far field directivity of the antenna 101 of the present invention.

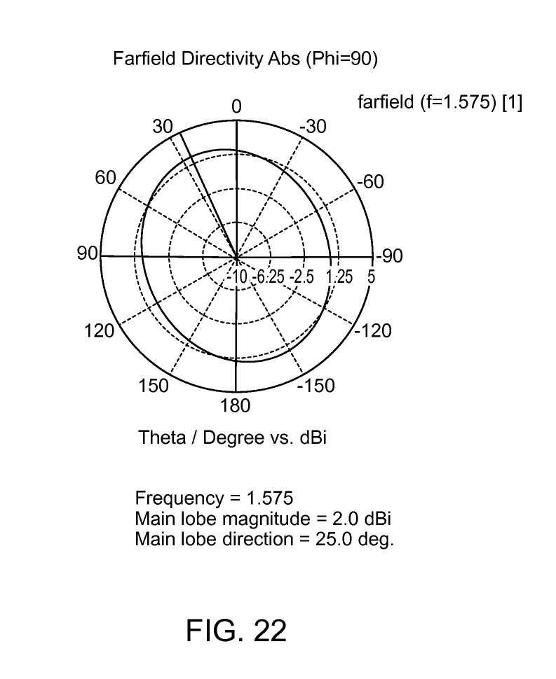

FIG. 22 illustrates another far field directivity of the antenna 101 of the present invention.

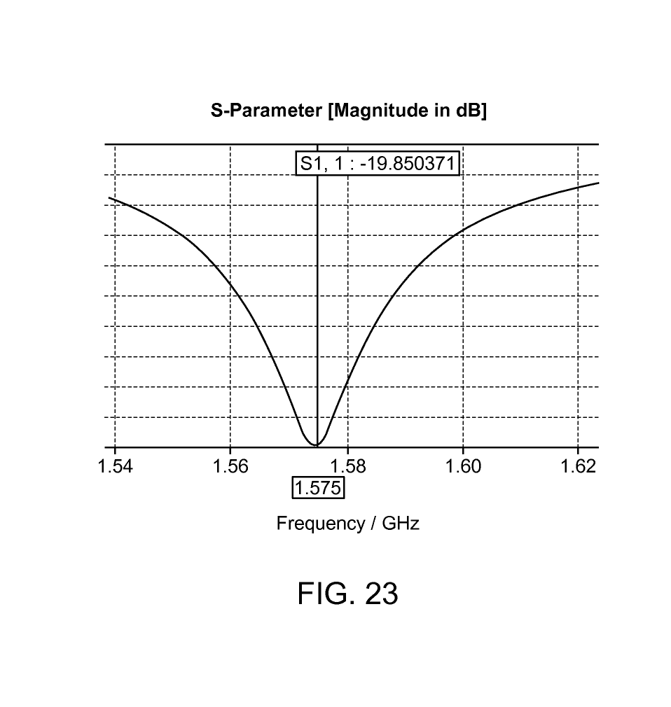

FIG. 23 illustrates the S-parameter of the antenna of the present invention.

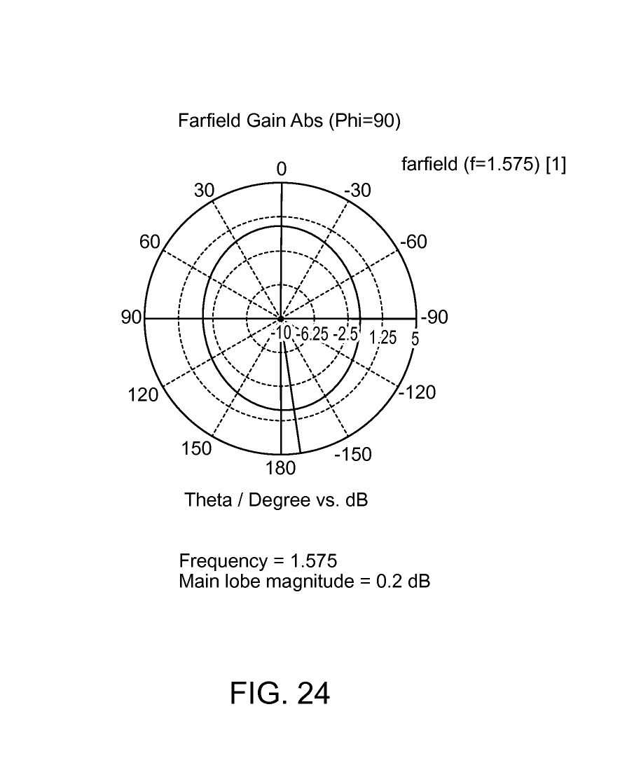

FIG. 24 illustrates far field directivity of the antenna of the present invention.

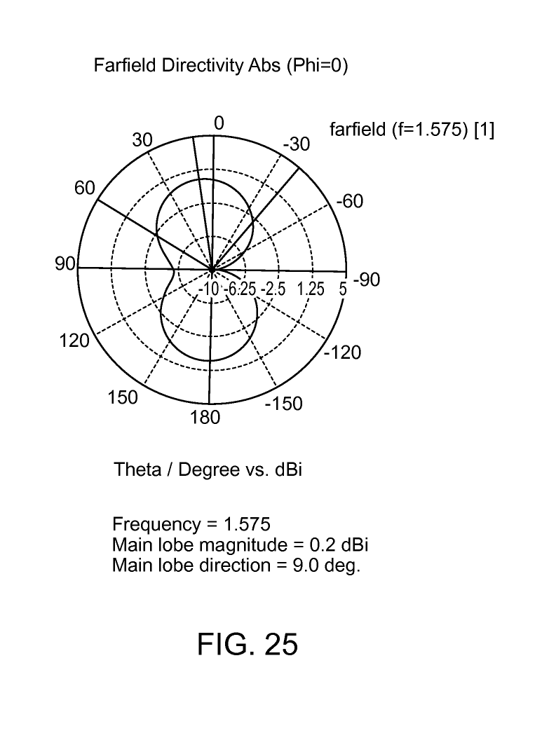

FIG. 25 illustrates far field directivity of the antenna of the present invention.

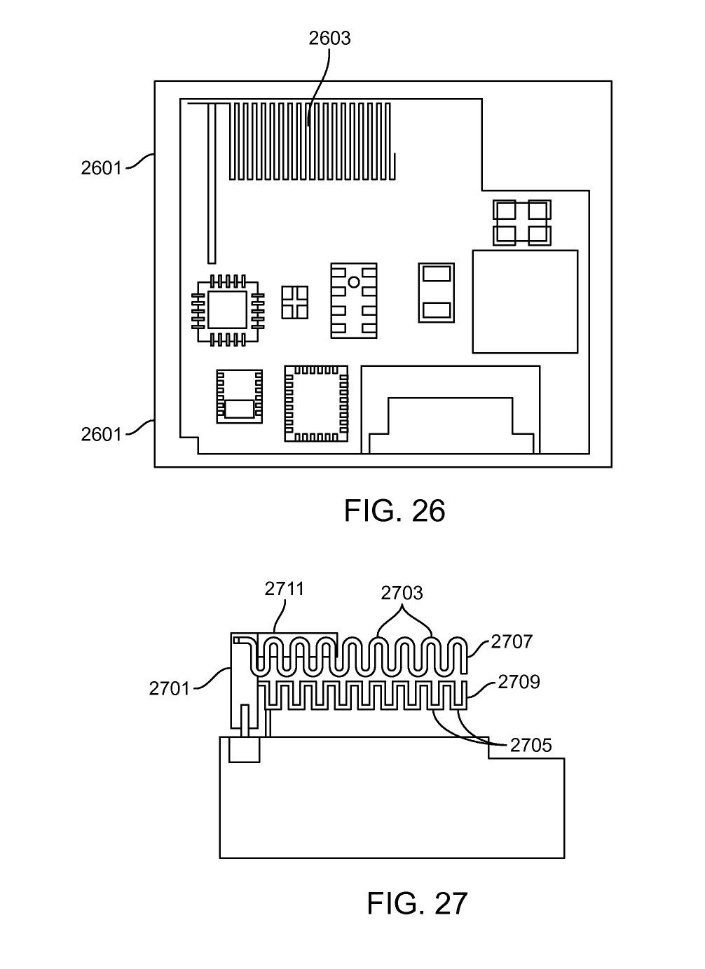

FIG. 26 illustrates antenna 2601 which may be connected to an active circuit 2607 and which may be configured to receive 1030 MHz RF (radio frequency) and can form an RF detector to detect RF signals. The antenna sections 2603 may be similar as described herein.

FIG. 27 illustrates antenna 2701 which may be configured to receive 2.4 GHz and 5.88 GHz Wi-Fi signals. The antenna 2701 may include only three rows of antenna sections, namely a first antenna row 2707, a second antenna row 2709 and a third antenna row 2711. The antenna sections 2703 of the first antenna 2701 may be similar to those described herein. The antenna sections 2705 of the second antenna 2709 may be a first L-shaped section and a second inverted L-shaped section. The third antenna row 2711 may be configured to receive 5 GHz, the first antenna row 2707 may be configured to receive GPS signals and the second antenna row 2709 may be configured to receive 2.4 GHz signals.

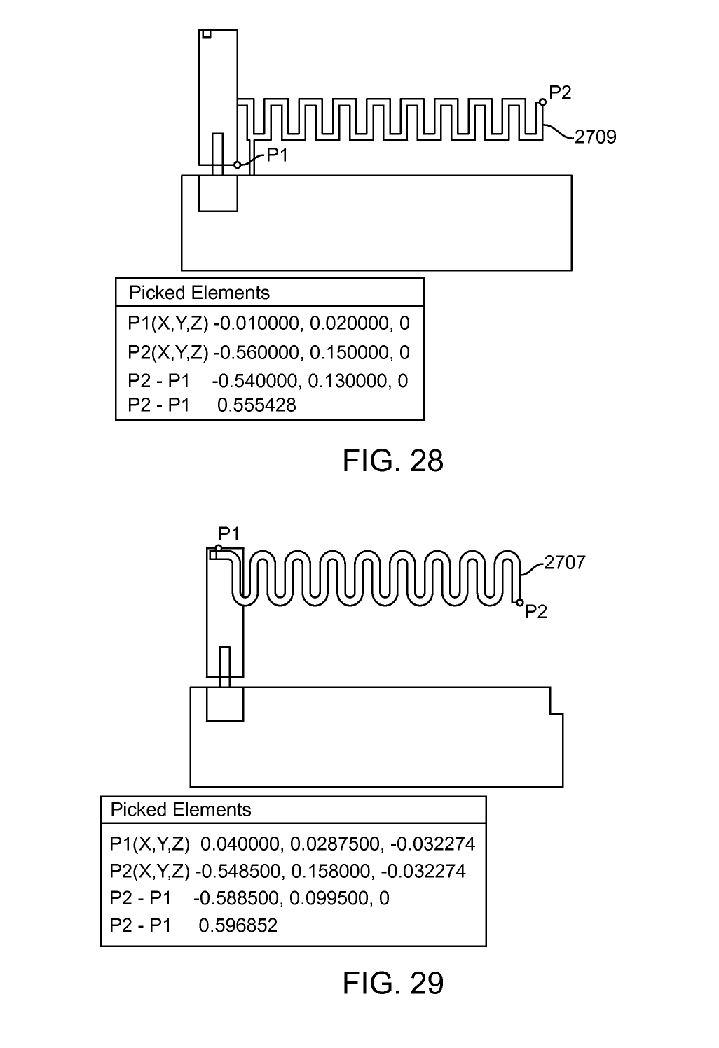

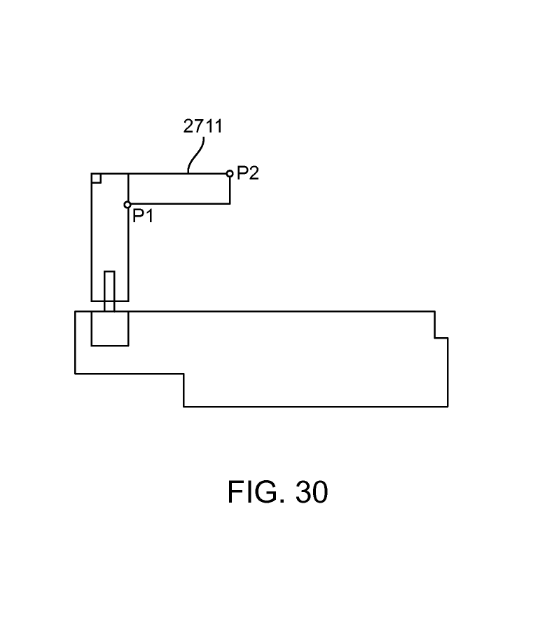

FIG. 28 and FIG. 29 illustrates the first row 2707 and the second row 2709 respectively, and FIG. 30 illustrates the third row 2711. FIG. 29 illustrates that the antenna 2707 may be a GPS antenna in FIG. 28 illustrates that the antenna 2709 may be a 2.4 GHz antenna for Wi-Fi. FIG. 30 illustrates the antenna 2711 which may be a 5.88 GHz antenna for Wi-Fi.

The range of the antennas of the present invention with substantially the same shape may be substantially from a lower frequency RF Detector at 1030 MHz to an upper frequency corresponding to the frequencies of Wi-Fi. The basic antenna pattern may be for example toward frequencies between 500 MHz and 5.88 Mhz, including Beidou, Compass, LTE, Galileo, GPS, GNSS, Glonass, 1030-1090 MHz RF Detection, 2.4 Wi-Fi, and 5.88 GHz WiFi

The active antennas may be for Beidou, Compass, Galileo, GPS, and GNSS.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. An antenna for receiving global positioning signals, comprising;
a first antenna section;
a second antenna section adjacent to the first antenna section to form a row of antenna sections;
wherein the first antenna section is connected to a first and second terminal to connect to a connecting plate.

2. An antenna for receiving global positioning signals as in claim 1, wherein the first antenna section includes a U-shaped section.

3. An antenna for receiving global positioning signals as in claim 1, wherein the first antenna section includes a inverted U-shaped section.

4. An antenna for receiving global positioning signals as in claim 1, wherein the first antenna section includes a first longitudinal section.

5. An antenna for receiving global positioning signals as in claim 1, wherein the first antenna section includes a second longitudinal section.

6. An antenna for receiving global positioning signals as in claim 1, wherein the second antenna section includes a U-shaped section.

7. An antenna for receiving global positioning signals as in claim 1, wherein the second antenna section includes inverted U-shaped section.

8. An antenna for receiving global positioning signals as in claim 1, wherein the second antenna section includes a first longitudinal section.

9. An antenna for receiving global positioning signals as in claim 1, wherein the second antenna section includes a second longitudinal section.
